(19) United States
(12) Patent Application Publication
(10) Pub. No.: US 2010/0318391 A1
(43) Pub. Date: Dec. 16, 2010

(54) METHOD AND COMPUTER PROGRAM PRODUCT FOR CHANGING AN IT SYSTEM

(76) Inventors: Ahi Gvirtsman, Tel Aviv (IL); David Trastour, Bristol (GB); Maher Rahmouni, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/867,107

(22) PCT Filed: Feb. 15, 2008
(86) PCT No.: PCT/EP2008/051894

§ 371 Date: Aug. 11, 2010

(51) Int. Cl. G06Q 10/00

(52) U.S. Cl. 705/7

(57) ABSTRACT

A method of changing an information technology system comprising a plurality of interacting components is provided. In an embodiment, the method comprises defining (320) a plurality of maintenance windows; providing (330) a database (110) of required component changes, each change comprising a workflow of at least one activity having a predefined duration, each change being labeled with a set of attributes including a list of acceptable maintenance windows; providing (340) a database listing said components and dependencies between said components; generating (350) change constraints for required component changes based on said dependencies and the required component changes; generating (360) a set of individual preference scores for the generated change constraints; and scheduling (370) changes in available maintenance windows using the individual preference scores. In addition, a computer program product is provided that, when executed on a computer, is adapted to execute at least some of the steps of an embodiment of the method of the present invention to provide a change schedule for an IT system.

The present invention relates to a method for changing an information technology system comprising a plurality of interacting components.

The present invention further relates to a computer program product for providing a change schedule for changing an information technology system comprising a plurality of interacting components.

The present invention yet further relates to a system comprising a computer including such a computer program.

Information technology (IT) systems such as networked systems have reached high levels of complexity. This complexity for instance manifests itself in the system comprising a large variety of hardware and software components between which complex dependencies exist. It is well-known that IT systems regularly require maintenance, e.g. because software and/or hardware components need rebooting, replacing, updating and so on. In the context of the present application, such maintenance tasks are generally referred to as changes, and are usually performed during pre-agreed maintenance windows. The complexity of the system under maintenance is reflected in the complexity of the maintenance task itself; because of the increasing volume of changes, it has become virtually impossible for a system manager to manually schedule the required changes during available maintenance windows.

For this reason, several at least partially automated processes have become available to help generate change schedules for IT systems. An example of such a process is the IT information library (ITIL). The IT Information Library defines several processes to enable IT service management. Change management is one such process. Its objective is to ensure that IT changes are recorded, evaluated, authorized, prioritized, planned, tested, implemented, documented and reviewed in a controlled manner; see for instance the ITIL Service Transition book, 3^{rd} version, which can be purchased on-line from http://www.itil.org.uk. Several ITIL compliant change management systems are available from various software vendors. These systems are useful in tracking, coordinating and visualising changes.

Another change management system is disclosed in ‘The CHAMPS System: Change Management with Planning and Scheduling’ by Keller et al. in Proceedings of the 9^{th} IEEE/IFIP Network Operations and Management Symposium (NOMS 2004), Seoul, Korea, 2004, pages 395-408. The CHAMPS system consists of a task graph builder and a planner & scheduler. The task graph builder is designed to determine temporal and location constraints of tasks needed to complete a request for change by creating reusable workflows from existing component dependency descriptions, whereas planner & scheduler uses the constructed task graph to construct a change schedule. The CHAMPS system is particularly designed to introduce a large degree of parallelism in the change process by parallelizing changes that are independent of each other.

Both prior art approaches assume that a feasible change schedule can be derived from the required changes and the associated constraints. However, in practice, the complexity of the set of constraints may be such that the known change management approaches cannot produce of a feasible change schedule, which forces an IT manager to redefine certain constraints and repeat the scheduling exercise. This not only is time-consuming, but also introduces an increased risk of the IT manager introducing conflicts in the schedule to be produced. Consequently, there exists a need for an improved change management method.

Embodiments of the invention are described in more detail and by way of non-limiting examples with reference to the accompanying drawings, wherein:

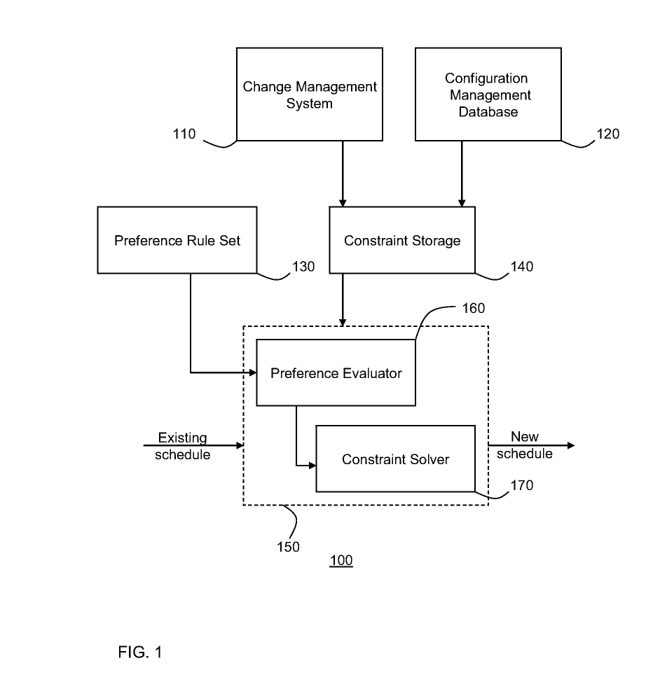

FIG. 1 schematically depicts an embodiment of a change schedule system of an embodiment of the present invention;

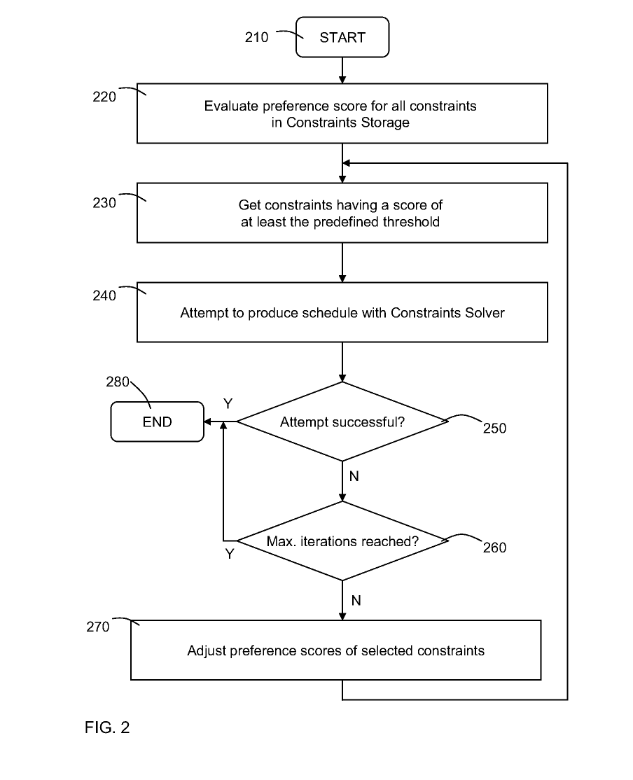

FIG. 2 schematically depicts a flowchart of an algorithm in accordance with an embodiment of the present invention; and

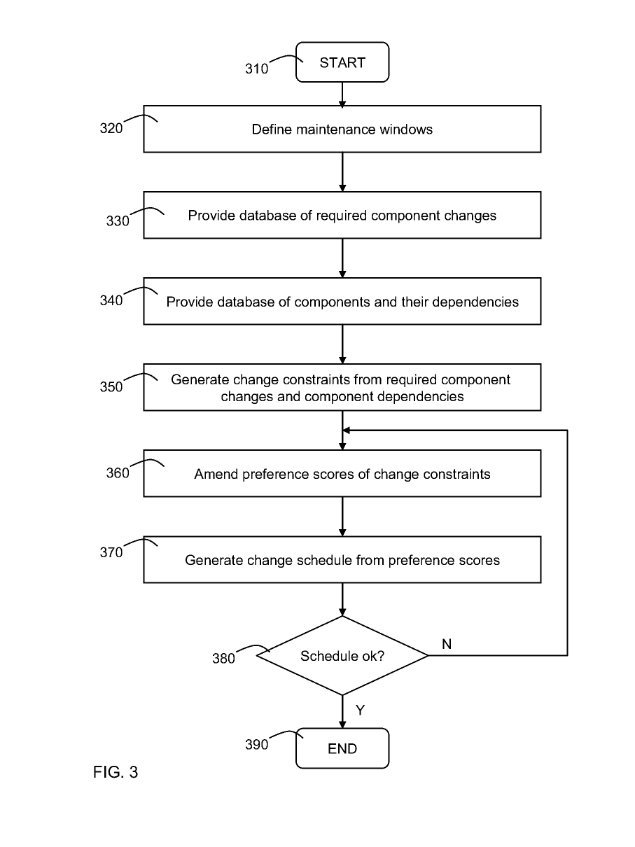

FIG. 3 schematically depicts a flowchart of an embodiment of the method of the present invention.

It should be understood that the Figures are merely schematic and are not drawn to scale. It should also be understood that the same reference numerals are used throughout the Figures to indicate the same or similar parts.

In this description, the following vocabulary is used to describe the change management domain, e.g. the system architecture 100 in accordance with an embodiment of the present invention as shown in FIG. 1. A change is composed of activities and can be assigned to one of several maintenance windows. Such maintenance windows may be user-defined, e.g. by the manager of the IT system.

Following ITIL terminology, any IT component that needs to be managed in order to deliver an IT service is called a configuration item (CI). A CI may be a hardware component or a software component. An activity changes a CI of the IT system. A component, or CI, is said to be a Changed CI (CCI) if it is directly changed by an activity. A CI is said to be an Affected CI (ACI) it has a dependency on a CCI (for instance a web server is an ACI if the underlying server is rebooted).

In an embodiment, each activity may require a skilled human resource such as a technician. The technician can be named explicitly in the activity. Alternatively, the activity can specify the required skill, e.g., a UNIX engineer.

The change management architecture of FIG. 1 is now explained in more detail.

The architecture comprises a first database 110, which constitutes a Change Management System (CMS). CMS 110 comprises the required component changes, which are sometimes referred to as requests for change (RFCs). Such an RFC typically includes a description of the component change, as well as component change attributes. Such attributes may include one or more of the following: a status of the change indicating the step in the change lifecycle (for instance “created”, “approved”, “implemented”, “closed”), a change deadline, and acceptable maintenance windows. The RFC further comprises the detailed workflow of each change, said workflow comprising a list of change activities subject to precedence constraints between them, e.g. activity A must be performed before activity B, and temporal constraints, e.g. activity A must start after 10 am, as well as details of each change activity. Such details may include duration, required skill or required technician for executing the activity.

CMS 110 may further include a calendar of available maintenance windows, and, in case the change activity details include required skill or a required technician, the CMS 110 may further include a calendar of available technicians. It will be appreciated that the data stored in CMS 110 requires little knowledge of the actual IT system to which the RFCs have to be applied. In other words, CMS 110 stores little dependency information other than the order of the activities in the RFC workflows. This makes it relatively straightforward for a systems manager, or any other suitable person, to add a RFC to CMS 110. The addition of a new RFC to CMS 110 may be realized in any suitable way, and will not be further discussed for reasons of brevity only.

The system architecture 100 further comprises a second database, i.e. configuration management database (CMDB) 120. The CMDB 120 lists details of all hardware and software components in the IT system to be changed. Such components are generally also referred to as configuration items (CI) in ITIL. The CMDB 120 further lists the dependencies between the components of the IT system. An example of such a dependency is “If server A is taken down then application 1 won't be available”, or “If application 2 is taken offline, business service B is unavailable”.

In other words, the CMDB 120 contains the IT system specific information which enables the definition of constraints on the execution of RFCs stored in CMS 110. In other words, the CMDB 120 typically comprises dependencies between components, whereas CMS 110 typically comprises constraints on the execution of changes. It will be appreciated that the respective data formats of the databases 110 and 120 do not have a material effect on the various embodiments of the present invention, and may be chosen to have any suitable data format.

The architecture 100 is designed to translate the information stored in CMS 110 and CMDB 120 into a set of constraints for a change request. Such a translation step typically involves the extraction of the relevant constraints information from the relevant request in CMS 110 and the associated components constraints in CMDB 120. These constraints may be kept in a constraints database such as constraint storage 140. The following types of constraints may be generated:
All changes must take place in one of the pre-agreed maintenance windows as specified in the corresponding change attribute;
All activities of a change must be performed in the same maintenance window;
Precedence constraints between all changes or activities must be respected;
Temporal constraints for changes or activities; e.g. deadline constraints such as must start on, must finish on, start no later than, finish no earlier than;
All activities must be performed by the named technician, if specified;
All activities must be performed by a technician having the required skill;
All technicians can only work on one activity at a time;
Among all activities of all changes, two activities cannot change concurrently the same CI (this is to avoid CCI-CCI conflicts);
A CI cannot be changed by an activity and affected by another (this is to avoid CCI-ACI conflicts) at the same time; and
A CI cannot be affected by two activities at the same time (this is to avoid ACI-ACI conflicts).

It will be appreciated that other suitable constraints that can be derived from the information in CMS 110 and CMDB 120 may also be used. Any changes in the content of CMS 110 or CMDB 120 trigger an update of the constraint storage 140.

As previously explained, most constraint-based change scheduling problems such as a constraint scheduling problem based on the above set of constraints turn out to be unsolvable, i.e. it is not possible to find schedules that satisfy all constraints, thus causing the need to relax certain constraints.

In accordance with an embodiment of the present invention, in order to reach a solution, i.e. produce a change schedule that can be executed during the available maintenance windows, a change manager, i.e. an IT manager responsible for managing the change process, may specify his preferences regarding the relaxation of constraints as well as the definition of preference scores for the changes in CMS 100 in the form of production rules, which may be provided in the form of a preference rule set 130.

Such preference rules may take the form of a conditional expression, e.g. IF condition THEN action. The condition of a rule can be on the type of constraint and/or on a change attribute, e.g. urgency, deadline, type of customer, and so on. The action of a rule can be used to adjust the preference score of the constraint. Examples of such adjustments include increasing a preference score, decreasing a preference score and assigning a fixed value to a preference score. For example, such a rule may read: “if the constraint is a deadline constraint and the impacted system is SAP, then increase the preference score by 5”. The preference rule set 130 is evaluated on all the constraints in the constraint store by a change scheduler 150, which will now be described in more detail.

In an embodiment, the change scheduler 150 comprises a preference evaluator 160 and a constraints solver 170. The preference evaluator 160 is configured to evaluate the preference rules in the preference rules set 130 and to assign a preference score to each constraint from constraints storage 140 based on these preference rules. In an embodiment, all constraints from constraints storage 140 have the same initial score, e.g. a preference score of 0. The preference evaluator 160 may be implemented by means of any suitable rule engine, e.g. the Drools system (http://labs.jboss.com/drools) and may apply priority rules to the assignment of preference scores from the preference rules set 130; e.g. the assignment of a fixed score has priority over increasing or decreasing a score. The preference evaluator 160 produces a preference score for each constraint.

The set of constraints with their individual preference scores is forwarded from the preference evaluator 160 to the constraints solver 170. The constraints solver 170 may be implemented by any suitable constraint solver, e.g. the JAVA-based Choco constraint programming system, also known as the Choco solver. The constraints solver 170 attempts to generate a change schedule based on the constraints and their preference scores received from preference evaluator 160. An embodiment of the method, or algorithm, applied by the constraints solver is given in FIG. 2. The method starts in step 210, after which the preference scores of all constraints from constraints storage 140 as provided by preference evaluator 160 are evaluated in step 220. In step 230, all constraints are selected for scheduling that meet a predefined threshold, e.g. at least have a predefined minimum value. The constraints scheduler attempts to provide an acceptable change schedule based on the selected constraints in step 240. If this attempt is successful, as checked in step 250, the method terminates in step 280.

If the scheduling attempt in step 240 is unsuccessful, the algorithm will check in step 260 if a pre-defined threshold, e.g. a maximum number of iterations or a time limit has been reached. If this is the case, the algorithm will again terminate in step 280 with the provision of the most recently produced schedule as a best attempt to find an acceptable change schedule. In an embodiment, the schedule produced after reaching the pre-defined threshold may be incomplete, i.e. some changes may have been scheduled, whereas other changes that could not be scheduled may have been omitted.

Otherwise, i.e. in case no feasible schedule could be provided, the algorithm will proceed to step 270 in which the preference scores of the selected constraints are modified. Such modifications may include the deletion of constraints having a low preference score, i.e. constraints that are deemed to have limited importance, or the adjustment of preference scores of constraints based on the preference rules provided by the IT manager. In an embodiment, a high preference score will lower the chance of a constraint to be relaxed. The algorithm subsequently reverts back to step 230. This process is repeated until an acceptable schedule or the maximum number of iterations is reached.

In an embodiment, in case a feasible, or acceptable, schedule cannot be reached, the constraint solver may perform an infeasibility analysis using techniques, e.g. a ‘Finding Irreducible Infeasible Systems’ algorithm. An example of such a technique is disclosed by O. Guieu et al. in “Analyzing Infeasible Mixed-Integer and Integer Linear Programs”, INFORMS Journal on Computing. Vol. 11 (1), 1999, pages 63-77. Such an analysis will reveal the potential constraints causing the infeasibility of the schedule to the IT Change Manager. This will help the IT Change Manager to take the right course of action to ensure a feasible schedule may be reached, e.g. changing constraint preferences, deleting constraints or even excluding certain changes.

A key element of any constraint solver is a clever branching strategy for traversing the search tree. In order to produce acceptable solutions within a reasonable timeframe, such a branching strategy should take into account the specificity of the problem to be solved. A branching strategy has to be able to, at any given iteration, choose which decision variable to assign which value from its domain. In the context of an embodiment of the present invention, such decision variables may be chosen from two sets of decision variables, namely a set of change decision variables Cⱼₖ which will be assigned a value from the possible maintenance windows and a set of activity decision variables Aᵢⱼₖ which will be assigned a start time in a specific maintenance window. In the previous notation, the index i runs over all activities of a change, the index j runs over all changes and the index k runs over all maintenance windows.

It has been realized that the assignment of a change to a change window is pointless unless all the activities of that change can all be assigned a starting time in the same change window. Consequently, any branching strategy should alternate between the assignment of a change and the assignment of all of its activities. In other words, if the present branching object is a change decision variable Cⱼₖ, another change decision variable Cₗₖ cannot be chosen until all decision variables of the activities associated with change Cⱼₖ have been explored.

In an embodiment of the present invention, a branching strategy is used that alternates between change decision variables and activity decision variables. Once a decision variable is chosen, the next step is a value assignment from its domain. It will be appreciated that any assignment strategy should look to assign values that maximize the chance of yielding an acceptable change schedule.

It has been found that for the problem of generating a change schedule, an ‘As Late As Possible’ approach for the assignment of change decision variables and an ‘As Soon As Possible’ approach for the assignment of activities decision variables are most successful in yielding acceptable change schedules.

In an embodiment, the change scheduler 150 is configured to receive an existing change schedule. The use of an existing schedule minimizes perturbations to existing schedules of changes, since the choice of the starting value for the exploration of a decision variable of an already scheduled change is the assigned value corresponding to the previous schedule.

One of the strengths of the scheduling approach of the present invention is that it is based on an optimization strategy. This not only allows the generation of acceptable schedules, but also allows the generation of schedules that optimize a given objective function. Almost any objective function can be plugged in the change scheduler 150. Examples of objective functions include maximizing the number of changes in change windows, minimizing the downtime of IT services, and minimizing the overall cost of the change process. Other suitable examples of objective functions will be apparent to the skilled person.

An embodiment of the method of the present invention, which may be implemented by system architecture 100, is depicted in the flowchart of FIG. 3. The method is initiated in step 310 after which the method proceeds to step 320 in which the available maintenance windows are defined, e.g. by the IT manager in the form of a calendar. Next, a database of required component changes, e.g. CMS 110 is provided in step 330 and a database of components and their dependencies, e.g. CMDB 120, is provided in step 340. The steps 320, 330 and 340 may be executed in any suitable order. In step 350, a set of change constraints e.g. constraints storage 140, is generated from the required component changes and the components and their dependencies, e.g. from CMS 110 and CMDB 120. Next, in step 360, the preference score for each change constraint is amended. In the context of step 360, amending includes setting the preference score. Step 360 may be based on user-defined preference rules, e.g. preference rules set 130.

Next, an attempt is made to generate a change schedule in step 370, and it is checked in step 380 if this attempt has been successful. If so, the method terminated in step 390. Otherwise, the method reverts back to step 360 to amend the preference scores of the change constraints, e.g. by altering preference scores of by deleting the constraint altogether, after which the generation of the change schedule is reattempted based on the altered preference scores, as also explained in the context of change scheduler 150.

The architecture 100 as shown in FIG. 1 may be implemented as a system that includes a computer (not shown) storing a computer program product, which may implement any of the aforementioned embodiments of the method of the present invention. In an embodiment, the computer program product is arranged to receive a plurality of maintenance windows, access change management system database 110 and configuration management system database 120. Both databases are part of the system. The computer program product is further arranged to generate the change constraints in constraint storage 140, to generate a set of individual preference scores for the generated change constraints and to schedule changes in available maintenance windows using the individual preference scores.

In a further embodiment, the computer program product may be arranged to generate a set of individual preference scores based on the preference rule set 130, and may be arranged to amend the preference scores using this rule set in case an acceptable schedule cannot be generated using the initial preference scores, as previously explained.

In another embodiment, the computer program product may be arranged to include the availability of skilled human resources in the scheduling procedure, as previously explained.

Since the implementation of the various embodiments of the method of the present invention in such a computer program product can be realized by the skilled practitioner in this field by employing his routine skills, such implementation details are omitted for the sake of brevity only.

The computer program product may be made available as a separate product for use with the aforementioned system, e.g. on a computer-readable data carrier such as a CD-ROM, DVD, memory stick, an internet-accessible server for downloading the computer program product, and so on.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of changing an information technology system comprising a plurality of interacting components, the method comprising:
defining (320) a plurality of maintenance windows;
providing (330) a database (110) of required component changes, each change comprising a workflow of at least one activity having a predefined duration, each change being labeled with a set of attributes including a list of acceptable maintenance windows;
providing (340) a database (120) listing said components and dependencies between said components;
generating (350) change constraints for required component changes based on said dependencies and the required component changes;
generating (360) a set of individual preference scores for the generated change constraints; and
scheduling (370) changes in available maintenance windows using the individual preference scores.

2. A method as claimed in claim 1, wherein each attribute further comprises a preference score production rule, and wherein the step of generating (360) the set of individual preference scores comprises generating said scores based on said preference score production rule.

3. A method as claimed in claim 1 or 2, further comprising the step of adjusting (360) the set of preference scores in case said scheduling step failed to produce an acceptable schedule, and subsequently repeating said scheduling step (370).

4. A method as claimed in any of claims 1-3, wherein each activity further requires a human resource for performing the activity, the method further comprising providing a calendar of available human resources, and wherein the step of generating (350) the change constraints includes generating said constraints based on the availability of the required human resource in the acceptable maintenance windows.

5. A method as claimed in any of claims 1-4, further comprising providing an existing change schedule, and wherein said scheduling step (370) comprises modifying the existing schedule.

6. A computer program product for providing an change schedule for changing an information technology system comprising a plurality of interacting components, said computer program product comprising software program code means adapted to perform, when executed by a computer, the steps of:
receiving a plurality of maintenance windows;
accessing a database (110) of required component changes, each change comprising a workflow of at least one activity having a predefined duration, each change being labeled with a set of attributes including a list of acceptable maintenance windows;
accessing a database 120) listing said components and dependencies between said components;
generating (350) change constraints for required component changes based on said dependencies and the required component changes;
generating (360) a set of individual preference scores for the generated change constraints; and
scheduling (370) changes in available maintenance windows using the individual preference scores.

7. A computer program product as claimed in claim 6, wherein each attribute further comprises a preference score production rule, and wherein the step of generating (360) the set of individual preference scores comprises generating said scores based on said preference score production rule.

8. A computer program product as claimed in claim 6 or 7, further adapted to perform the step of adjusting (360) the set of preference scores in case said scheduling step (370) failed to produce an acceptable schedule, and subsequently repeating said scheduling step (370).

9. A computer program product as claimed in any of claims 6-8, wherein each activity further requires a human resource for performing the activity, said computer program product being further adapted to access a calendar of available human resources, and wherein the step (350) of generating the change constraints includes generating said constraints based on the availability of the required human resource in the acceptable maintenance windows.

10. A computer program product as claimed in any of claims 6-9, further adapted to access an existing change schedule, and wherein said scheduling step (370) comprises modifying the existing schedule.

11. A computer-readable data carrier comprising the computer program product of any of claims 6-10.

12. A system comprising a computer storing a computer program product as claimed in any of claims 6-10, the system further comprising:
a database (110) of required component changes, each change comprising a workflow of at least one activity having a predefined duration, each change being labeled with a set of attributes including a list of acceptable maintenance windows; and
a database (120) listing said components and dependencies between said components.
